(19) United States
(12) Patent Application Publication
(10) Pub. No.: US 2012/0084482 A1
(43) Pub. Date: Apr. 5, 2012

(54) SEMICONDUCTOR DATA PROCESSING DEVICE AND DATA PROCESSING SYSTEM

(75) Inventors: Satoshi Yamanaka, Tokyo (JP); Yoshifumi Kawamura, Kanagawa (JP)

(73) Assignee: RENESAS ELECTRONICS CORPORATION

(21) Appl. No.: 13/244,443

(22) Filed: Sep. 24, 2011

(30) Foreign Application Priority Data
Oct. 4, 2010 (JP) 2010-224534

(51) Int. Cl. G06F 13/14

(52) U.S. Cl. 710/305

(57) ABSTRACT

A communication control function is implemented with limited hardware resources without hampering the extensibility and degrading the processing performance. In an electric control unit coupled to a network bus comprises a reconfiguration module using for processing message received from the network bus. The reconfiguration module is made for configuring the processing circuit in accordance with the message transferred on the network bus to be processed.

### CROSS-REFERENCE TO RELATED APPLICATIONS

The disclosure of Japanese Patent Application No. 2010-224534 filed on Oct. 4, 2010 including the specification, drawings and abstract is incorporated herein by reference in its entirety.

### BACKGROUND

The present invention relates to a semiconductor data processing device incorporating a function reconfiguration module in which a communication control function is set and a data processing system, and particularly to a technique effectively applied to e.g. an in-vehicle network system in which multiple electronic control units are coupled to a network bus.

Multiple ECUs (Electronic Control Units) for controlling an engine system, a braking system, a console system, a body system, and the like are adopted and coupled to a CAN (Controller Area Network) bus of an in-vehicle network system. Each ECU is configured with, e.g., a microcomputer. As typified by in-vehicle ECUs, execution of processing related to each ECU increases the number of CAN frames transmitted by an ECU; accordingly, there is a demand to set priorities to transmission frames within the ECU to transmit CAN frames at various timings according to the priorities. Further, in the case of adopting a gateway function in which an ECU functions as a gateway of another ECU, there is required management for the respective IDs of CAN frames such as shifting transmission timings for the respective IDs of CAN frames to adjust a bus load on the transmission side. Accordingly, communication control processing of information frames in the ECU continues to become complicated. On this account, the AUTOSAR (Automotive Open System Architecture) standard exists for the purpose of standardizing communication control processing by the ECU.

To cope with the complicated communication control processing of information frames in the ECU, conversion to hardware one by one or extension by software can be adopted. However, the conversion to hardware brings about low correspondency in the increased number of processing factors or processing data items, and additional hardware is required for each combination of these conditions. On the other hand, the extension by software has higher flexibility in correspondency than the conversion to hardware; however, the increased number of processing factors or processing data items causes a problem that program processing becomes complicated and the load becomes excessive. Although it is possible to combine the conversion to hardware and the extension by software; depending on the separation between hardware processing and software processing, the extensibility might be hampered and the processing performance might deteriorate, so that it is not easy to implement it.

There has conventionally been provided an FPGA (Field-Programmable Gate Array) which is an integrated circuit whose configuration can be set by a purchaser or a designer after production. The FPGA includes a plurality of programmable logic blocks which are coupled in an array form through a number of lines for reconfiguring the intercoupling. With the FPGA, it is possible to implement variable hardware configuration. Japanese Unexamined Patent Publication No. 2008-287708 describes a reconfiguration arithmetic circuit as an alternative to the FPGA. The reconfiguration arithmetic circuit includes a scan chain configured with a plurality of registers, and information transferred by the scan chain enables feedback arithmetic processing. WO2008/143285 also describes a semiconductor device for implementing a variable logic function for enabling feedback arithmetic processing. The feedback arithmetic processing signifies autonomous data processing which implements a mass of processing by repeating processing in which a set variable logic function invokes a function set to itself to determine the next processing.

### SUMMARY

However, in order not to hamper the extensibility and degrade the processing performance in communication control for dealing with a wide variety of processing factors and a number of processing data items as typified by in-vehicle ECUs, the present inventors have found that they had to examine not only the conception of merely using the variable logic function for enabling feedback arithmetic processing but also a logic function configuration for data processing for a specific communication control mode and logic function setting for flexibly implementing a logic function reconfiguration with the limited hardware resources of the variable logic function.

It is an object of the present invention to provide a semiconductor data processing device that can implement a communication control function with limited hardware resources without hampering the extensibility and degrading the processing performance.

It is another object of the invention to achieve both the extensibility and performance improvement of a communication control function in a data processing system in which a plurality of electronic control units are coupled to a network bus.

The above and other objects and novel features of the present invention will become apparent from the description of this specification and the accompanying drawings.

A typical aspect of the invention disclosed in the present application will be briefly described as follows.

In an electric control unit coupled to a network bus comprises a reconfiguration module using for processing message received from the network bus.

Effects obtained by the typical aspect of the invention disclosed in the present application will be briefly described as follows.

It is possible to implement a communication control function with the limited hardware resources of a semiconductor data processing device without hampering the extensibility and degrading the processing performance.

Further, it is possible to contribute to the extensibility and performance improvement of a communication control function in a data processing system in which a plurality of electronic control units are coupled to a network bus.

### BRIEF DESCRIPTION OF THE DRAWINGS

FIG. 1 is a block diagram illustrating the configuration of a microcomputer MCU incorporated in an ECU;

FIG. 2 is a block diagram showing a schematic configuration of an in-vehicle network system as an example of a data processing system according to the invention;

FIG. 3 is a block diagram illustrating a schematic configuration of a function reconfiguration module;

FIG. 4 is a block diagram illustrating the details of an input data determination unit;

FIG. 5 is a block diagram illustrating the details of a transmission packet generation unit;

FIG. 6 is an explanatory diagram illustrating a packet shown as a PDU (Protocol Data Unit);

FIG. 7 is a block diagram illustrating the details of a sequence control unit;

FIG. 8 is an explanatory diagram illustrating an example of a selection control table;

FIG. 9 is an explanatory diagram illustrating the selection sequence of table data retrieved using the selection control table in FIG. 8;

FIG. 10 is a block diagram illustrating the details of a packet transfer unit;

FIG. 11 is an explanatory diagram showing the case of dynamically adding or switching a transmission data processing function set in the function reconfiguration module;

FIG. 12 is a block diagram illustrating the details of an input packet determination unit;

FIG. 13 is a block diagram illustrating the details of a data extraction unit;

FIG. 14 is a block diagram showing the case where a transfer destination unit is a RAM, as an example of the details of a data transfer unit;

FIG. 15 is a block diagram showing the case where a transfer destination unit is a transmission data processing function unit thereby to implement a gateway, as an example of the details of the data transfer unit;

FIG. 16 is a block diagram illustrating the case of dynamically adding or switching a reception data processing function set in the function reconfiguration module;

FIG. 17 is a block diagram illustrating the details of a function reconfiguration cell;

FIG. 18 is a block diagram illustrating the details of the array configuration of a plurality of function reconfiguration cells;

FIG. 19 is a block diagram illustrating the details of the overall configuration of the function reconfiguration module;

FIG. 20 is an explanatory diagram illustrating the state of address mapping for a memory circuit of the function reconfiguration cell;

FIG. 21 is an explanatory diagram showing the basic concept of a logic operation in the function reconfiguration cell; and

FIG. 22 is a flowchart illustrating the basic form of an operation sequence for the logic operation in FIG. 21.

### DETAILED DESCRIPTION

### 1. Outline of Embodiments

First, exemplary embodiments of the invention disclosed in the present application will be outlined.

In an electronic control unit coupled to a network bus, a function reconfiguration module in which a data processing function according to function definition data written by a central processing unit is set has, as a transmission data processing function unit, an input data determination unit for determining a data ID of transmission data sequentially generated and supplied through data processing by the central processing unit, a plurality of transmission packet generation units each for receiving transmission data corresponding to a data ID determination result by the input data determination unit and configuring a packet to be transmitted, a sequence control unit for controlling transmission sequence of the packet generated by each transmission packet generation unit and outputting the packet, and a packet transfer unit for providing the packet outputted from the sequence control unit to an external interface circuit.

With this, it is possible to manage the generation of the packet using the data ID for the transmission data generated by the central processing unit, perform transmission priority control of the generated packet, and perform transfer data control by providing the packet that has undergone the priority control to the external interface circuit. Since a logic function set as a variable logic function is divided broadly into the above units, no packet generation logic function corresponding to the data ID is coped with by exchanging logic functions, which facilitates effective utilization of limited hardware resources for function reconfiguration.

Following, more details of the exemplary embodiments of the inventions describe. Reference numerals in the drawings that refer to with parentheses applied thereto in the outline description of the exemplary embodiments are merely illustration of ones contained in the concepts of components marked with the reference numerals.

[1] Function Reconfiguration Module in which Data Processing Function for Transmission is Set

A semiconductor data processing device (MCU) according to an exemplary embodiment of the invention has an external interface circuit (113), a function reconfiguration module (114) in which a logic function according to written function definition data is set, and a central processing unit (110) which writes the function definition data to the function reconfiguration module to set and uses the data processing function, which is activated by being stored the function definition data into the function reconfiguration module. The function reconfiguration module in which the data processing function has been set has, as a transmission data processing function unit (120), an input data determination unit (121) for determining a data ID of transmission data sequentially generated and supplied through data processing by the central processing unit, a plurality of transmission packet generation units (122) each for receiving transmission data corresponding to a data ID determination result by the input data determination unit and configuring a packet to be transmitted, a sequence control unit (123) for controlling transmission sequence of the packet generated by each transmission packet generation unit and outputting the packet, and a packet transfer unit (124) for providing the packet outputted from the sequence control unit to the external interface circuit.

With this, it is possible to manage the generation of the packet using the data ID for the transmission data generated by the central processing unit, perform transmission priority control of the generated packet, and perform transfer data control by providing the packet that has undergone the priority control to the external interface circuit. Since the logic function set as a variable logic function is divided broadly into the above units, no packet generation logic function corresponding to the data ID is coped with by exchanging logic functions, which facilitates effective utilization of limited hardware resources for function reconfiguration.

Accordingly, it is possible to implement a communication control function with the limited hardware resources of the semiconductor data processing device without hampering the extensibility and degrading the processing performance. Further, it is possible to contribute to the extensibility and performance improvement of a communication control function in a data processing system in which a plurality of electronic control units are coupled to a network bus.

[2] Request for Function Setting for Non-Existent Transmission Packet Generation Unit

In the semiconductor data processing device according to item 1, if there is no transmission packet generation unit corresponding to a determination result by the input data determination unit, the function reconfiguration module makes a request to the central processing unit for function setting of a necessary transmission packet generation unit, and resumes processing of the transmission data after the function is set.

The absence of a transmission packet generation unit corresponding to the data ID can be coped with by adding the function. Since logic function setting can be added as needed, it can be coped with by exchanging set logic functions with limited hardware resources for function reconfiguration.

[3] Request for Function Setting for Non-Existent Packet Transfer Function

In the semiconductor data processing device according to item 2, when the function reconfiguration module makes the request for the function setting of the necessary transmission packet generation unit, the function reconfiguration module also makes a request to set, in the packet transfer unit, a transfer function for a packet generated by the transmission packet generation unit set by the request.

The absence of a transfer control function for the packet corresponding to the data ID also can be coped with by adding the function. Since logic function setting can be added as needed, it can be coped with by exchanging set logic functions with limited hardware resources for function reconfiguration.

[4] Details of Input Data Determination Unit

In the semiconductor data processing device according to item 1, the input data determination unit has a decoder (140) for decoding the data ID and a data selector (141) for outputting the transmission data and the data ID to a transmission packet generation unit corresponding to the data ID based on a decoding result by the decoder.

By separating decode logic and select logic, it becomes possible to easily deal with change in transmission determination logic.

[5] Details of Transmission Packet Generation Unit

In the semiconductor data processing device according to item 4, the transmission packet generation unit has a data buffer memory (150), a pack unit (151) for storing the transmission data supplied from the input data determination unit in the data buffer memory in accordance with a predetermined packet format to generate a packet, and a packet selector (152) for sending the packet stored in the data buffer memory to the sequence control unit at the time of occurrence of a predetermined event.

It is possible to easily deal with logic functions for transmission packet generation units of different data IDs by changing the definition of the packet format in the pack unit. Further, it is possible to easily deal with the addition and change of a packet transmission trigger by changing the function setting of the packet selector.

[6] Details of Sequence Control Unit

In the semiconductor data processing device according to item 5, the sequence control unit has a packet buffer memory (170) for storing the packet supplied from the transmission packet generation unit in association with the transmission packet generation unit and a priority control selector (171) for selecting the packet in the packet buffer memory in accordance with a priority order determined based on a priority of the packet stored in the packet buffer memory and earliness of packet storage into the packet buffer memory.

It is possible to variably perform priority control of packet transmission order and easily deal with a complicated processing request for packet transmission.

[7] Details of Packet Transfer Unit

In the semiconductor data processing device according to item 6, the packet transfer unit has a transfer gate (182) for providing the packet selected by the priority control selector to the external interface circuit that is ready for transmission.

It is possible to transfer the transmission packet from the function reconfiguration module to the external interface circuit in accordance with the state of the external interface circuit.

[8] Generation Trigger for Transmission Data and ID

In the semiconductor data processing device according to item 1, in response to an interrupt request according to a type of occurred event, the central processing unit starts data processing, generates transmission data and a data ID, and supplies the generated transmission data and data ID to the function reconfiguration module.

It is possible to generate the required transmission data and the data ID in accordance with a program which the central processing unit executes in response to the event.

[9] Transmission Trigger for Packet and ID

In the semiconductor data processing device according to item 8, the transmission packet generation unit sends the generated packet to the sequence control unit at the time of occurrence of a predetermined event signal.

It is possible to use the type of occurrence event as a packet transmission trigger.

[10] Timer Counter Unit for Generating Event

In the semiconductor data processing device according to item 9, the transmission packet generation unit has a timer counter unit (162) for generating the predetermined event signal.

It is possible to send the packet to the sequence control unit, using time-out according to an arbitrary count-up value set in the timer counter unit as a transmission trigger.

[11] Event Determination Unit for Determining External Event

In the semiconductor data processing device according to item 9, the transmission packet generation unit has a data buffer memory (150) for storing the transmission data supplied from the input data determination unit in accordance with a predetermined packet format, and has an event determination unit (161) for comparing data supplied from outside the function reconfiguration module with corresponding data already stored in the data buffer memory and generating the predetermined event signal if a predetermined condition holds.

It is possible to send the packet to the sequence control unit in response to the occurrence of the predetermined event.

[12] Function Reconfiguration Module

In the semiconductor data processing device according to item 1, the function reconfiguration module has a function reconfiguration array (ARY) in which a plurality of function reconfiguration cells (20) each having a memory circuit (23) and a control circuit (24) are arranged in chains through lines (HL0 to HLn and VL0 to VLm) and an interface control circuit (21) for controlling a function reconfiguration cell in response to an access request from outside. The function reconfiguration cell performs a logic operation by repeating an operation in which the control circuit receives a signal read from the memory circuit or a signal supplied from outside, accesses the memory circuit in accordance thereto, and determines a next access address to the memory circuit based on a thereby obtained signal. The memory circuit stores function definition data for defining the logic operation and data to be operated in the logic operation.

With this, the function reconfiguration cell can autonomously control the reading of the memory circuit, so that the memory circuit for implementing variable logic functions can be treated as a circuit equivalent to a logic circuit. Accordingly, it is possible to provide flexibility to feasible logical configuration and size. Further, it becomes possible to implement variable logic functions that can support a large logical size in a small chip occupation area. Furthermore, in comparison with a program processing apparatus which fetches and executes sequential instructions, feedback processing in which each function reconfiguration cell determines the next operation based on data read from the memory circuit is repeated, which can contribute to the speed enhancement of the logic operation.

[13] Function Reconfiguration Module in which Data Processing Function for Reception is Set

A semiconductor data processing device (MCU) according to another embodiment of the invention has an external interface circuit (113), a function reconfiguration module (114) in which a logic function according to written function definition data is set, and a central processing unit (110) which writes the function definition data to the function reconfiguration module to set, in the function reconfiguration module, a data processing function of data which the external interface circuit interfaces, and uses the set data processing function. The function reconfiguration module in which the data processing function has been set has, as a reception data processing function unit (130), an input packet determination unit (131) for determining a packet ID of a reception packet supplied from the external interface circuit, a data extraction unit (132) for extracting necessary reception data based on a configuration of a packet corresponding to a packet ID determination result by the input packet determination unit, adding a corresponding data ID to the reception data, and storing them, and a data transfer unit (133) for supplying the reception data and the data ID stored in the data extraction unit to a transfer destination unit in accordance with a state of the transfer destination unit.

With this, it is possible to manage, using the data ID, the reception data corresponding to the packet ID of the received packet and control the transfer of the reception data in accordance with the state of the transfer destination unit corresponding to the data ID. Since the logic function set as a variable logic function is divided broadly into the input packet determination unit, the data extraction unit, and the data transfer unit, no definition information for data extraction corresponding to the packet ID can be coped with by addition or exchange and no transfer destination definition information corresponding to the data ID can be coped with by addition or exchange, which facilitates effective utilization of limited hardware resources for function reconfiguration.

Accordingly, it is possible to implement a communication control function with the limited hardware resources of the semiconductor data processing device without hampering the extensibility and degrading the processing performance. Further, it is possible to contribute to the extensibility and performance improvement of a communication control function in a data processing system in which a plurality of electronic control units are coupled to a network bus.

[14] Request for Function Setting for Non-Existent Data Extraction Function

In the semiconductor data processing device according to item 13, if a function of the data extraction unit corresponding to the packet ID determined by the input packet determination unit is not set, the function reconfiguration module makes a request to the central processing unit for necessary function setting of the data extraction unit, and resumes processing of the packet after the function is set.

No function setting for data extraction corresponding to the packet ID can be coped with by adding the function. Since logic function setting can be added as needed, it can be coped with by exchanging set logic functions with limited hardware resources for function reconfiguration.

[15] Request for Function Setting for Non-Existent Data Transfer Function

In the semiconductor data processing device according to item 14, if a function of the data transfer unit to the transfer destination unit corresponding to the reception data and the data ID is not set, the function reconfiguration module makes a request to the central processing unit for necessary function setting of the data transfer unit, and outputs the reception data and the data ID to the transfer destination unit after the function is set.

No function setting of the data transfer unit corresponding to the data ID can be coped with by adding the function. Since logic function setting can be added as needed, it can be coped with by exchanging set logic functions with limited hardware resources for function reconfiguration.

[16] Details of Data Extraction Unit

In the semiconductor data processing device according to item 15, the data extraction unit has a data buffer memory (200) and an unpack unit (202) for separating the reception data from the packet based on the configuration of the packet corresponding to the packet ID determination result by the input packet determination unit, adding the corresponding data ID to the separated reception data, and storing them in the data buffer memory.

It is possible to easily deal with unpacking of packets of different packet IDs by changing the definition of the packet format in the unpack unit.

[17] Function Reconfiguration Module

In the semiconductor data processing device according to item 13, the function reconfiguration module has a function reconfiguration array in which a plurality of function reconfiguration cells each having a memory circuit and a control circuit are arranged in chains through lines and an interface control circuit for controlling a function reconfiguration cell in response to an access request from outside. The function reconfiguration cell performs a logic operation by repeating an operation in which the control circuit receives a signal read from the memory circuit or a signal supplied from outside, accesses the memory circuit in accordance thereto, and determines a next access address to the memory circuit based on a thereby obtained signal. The memory circuit stores function definition data for defining the logic operation and data to be operated in the logic operation.

Item 17 provides the same operational effects as item 12.

[18] ECU System

A data processing system according to another embodiment of the invention is configured by coupling a plurality of electronic control units (101 to 105) to a network bus (100). The electronic control units each have an external interface circuit (113), a function reconfiguration module (114) in which a logic function according to written function definition data is set, and a central processing unit (110) which writes the function definition data to the function reconfiguration module to set a transmission data processing function and a reception data processing function of data which the external interface circuit transmits and receives, and uses the set transmission data processing function and reception data processing function. The function reconfiguration module in which the transmission data processing function and the reception data processing function have been set has a transmission data processing function unit (120) and a reception data processing function unit (130). The transmission data processing function unit has an input data determination unit (121) for determining a data ID of transmission data sequentially generated and supplied through data processing by the central processing unit, a plurality of transmission packet generation units (122) each for receiving transmission data corresponding to a data ID determination result by the input data determination unit and configuring a packet to be transmitted, a sequence control unit (123) for controlling transmission sequence of the packet generated by each transmission packet generation unit and outputting the packet, and a packet transfer unit (124) for providing the packet outputted from the sequence control unit to the external interface circuit. The reception data processing function unit has an input packet determination unit (131) for determining a packet ID of a reception packet supplied from the external interface circuit, a data extraction unit (132) for extracting necessary reception data based on a configuration of a packet corresponding to a packet ID determination result by the input packet determination unit, adding a corresponding data ID to the reception data, and storing them, and a data transfer unit (133) for supplying the reception data and the data ID stored in the data extraction unit to a transfer destination unit in accordance with a state of the transfer destination unit.

With this, it is possible to manage the generation of the packet using the data ID for the transmission data generated by the central processing unit, perform transmission priority control of the generated packet, and perform transfer data control by providing the packet that has undergone the priority control to the external interface circuit. Since the logic function set as a variable logic function is divided broadly into the above units, no packet generation logic function corresponding to the data ID is coped with by exchanging logic functions, which facilitates effective utilization of limited hardware resources for function reconfiguration.

Further, it is possible to manage, using the data ID, the reception data corresponding to the packet ID of the received packet and control the transfer of the reception data in accordance with the state of the transfer destination unit corresponding to the data ID. Since the logic function set as a variable logic function is divided broadly into the input packet determination unit, the data extraction unit, and the data transfer unit, no definition information for data extraction corresponding to the packet ID can be coped with by addition or exchange and no transfer destination definition information corresponding to the data ID can be coped with by addition or exchange, which facilitates effective utilization of limited hardware resources for function reconfiguration.

Accordingly, it is possible to implement a communication control function with the limited hardware resources of the electronic control unit without hampering the extensibility and degrading the processing performance. Further, it is possible to contribute to the extensibility and performance improvement of a communication control function in a data processing system in which a plurality of electronic control units are coupled to a network bus.

[19] Request for Function Setting for Non-Existent Transmission Packet Generation Unit

In the data processing system according to item 18, if there is no transmission packet generation unit corresponding to a determination result by the input data determination unit, the function reconfiguration module makes a request to the central processing unit for function setting of a necessary transmission packet generation unit, and resumes processing of the transmission data after the function is set.

No transmission packet generation unit corresponding to the data ID can be coped with by adding the function. Since logic function setting can be added as needed, it can be coped with by exchanging set logic functions with limited hardware resources for function reconfiguration.

[20] Request for Function Setting for Non-Existent Packet Transfer Function

In the data processing system according to item 19, when the function reconfiguration module makes the request for the function setting of the necessary transmission packet generation unit, the function reconfiguration module also makes a request to set, in the packet transfer unit, a transfer function for a packet generated by the transmission packet generation unit set by the request.

No output interface function for the packet corresponding to the data ID also can be coped with by adding the function. Since logic function setting can be added as needed, it can be coped with by exchanging set logic functions with limited hardware resources for function reconfiguration.

[21] Request for Function Setting for Non-Existent Data Extraction Function

In the data processing system according to item 20, if a function of the data extraction unit corresponding to the packet ID determined by the input packet determination unit is not set, the function reconfiguration module makes a request to the central processing unit for necessary function setting of the data extraction unit, and resumes processing of the packet after the function is set.

No function setting for data extraction corresponding to the packet ID can be coped with by adding the function. Since logic function setting can be added as needed, it can be coped with by exchanging set logic functions with limited hardware resources for function reconfiguration.

[22] Request for Function Setting for Non-Existent Data Transfer Function

In the data processing system according to item 21, if a function of the data transfer unit to the transfer destination unit corresponding to the reception data and the data ID is not set, the function reconfiguration module makes a request to the central processing unit for necessary function setting of the data transfer unit, and outputs the reception data and the data ID to the transfer destination unit after the function is set.

No function setting of the data transfer unit corresponding to the data ID can be coped with by adding the function. Since logic function setting can be added as needed, it can be coped with by exchanging set logic functions with limited hardware resources for function reconfiguration.

[23] Generation Trigger for Transmission Data and ID

In the data processing system according to item 18, in response to an interrupt request according to a type of occurred event, the central processing unit starts data processing, generates transmission data and a data ID, and supplies the generated transmission data and data ID to the function reconfiguration module.

It is possible to generate the required transmission data and the data ID in accordance with a program which the central processing unit executes in response to the event.

[24] Transmission Trigger for Packet and ID

In the data processing system according to item 23, the transmission packet generation unit sends the generated packet to the sequence control unit at the time of occurrence of a predetermined event signal.

It is possible to use the type of occurrence event as a packet transmission trigger.

[25] Timer Counter Unit for Generating Event

In the data processing system according to item 24, the transmission packet generation unit has a timer counter unit (162) for generating the predetermined event signal.

It is possible to send the packet to the sequence control unit, using time-out according to an arbitrary count-up value set in the timer counter unit as a transmission trigger.

[26] Event Determination Unit for Determining External Event

In the data processing system according to item 24, the transmission packet generation unit has a data buffer memory (150) for storing the transmission data supplied from the input data determination unit in accordance with a predetermined packet format and an event determination unit (161) for comparing data supplied from outside the function reconfiguration module with corresponding data already stored in the data buffer memory and generating the predetermined event signal if a predetermined condition holds.

It is possible to send the packet to the sequence control unit in response to the occurrence of the predetermined event.

[27] Function Reconfiguration Module

In the data processing system according to item 18, the function reconfiguration module has a function reconfiguration array (ARY) in which a plurality of function reconfiguration cells (20) each having a memory circuit (23) and a control circuit (24) are arranged in chains through lines (HL0 to HLn and VL0 to VLm) and an interface control circuit (21) for controlling a function reconfiguration cell in response to an access request from outside. The function reconfiguration cell performs a logic operation by repeating an operation in which the control circuit receives a signal read from the memory circuit or a signal supplied from outside, accesses the memory circuit in accordance thereto, and determines a next access address to the memory circuit based on a thereby obtained signal. The memory circuit stores function definition data for defining the logic operation and data to be operated in the logic operation.

Item 27 provides the same operational effects as item 12.

### 2. Details of Embodiments

Embodiments will be described in greater detail below.

<<In-Vehicle Network System>>

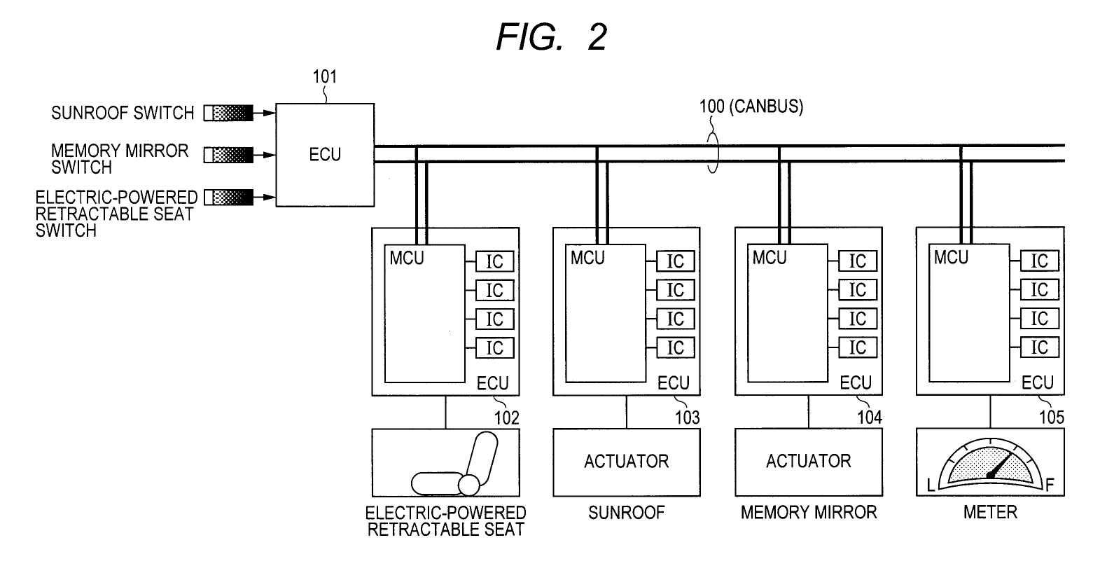

FIG. 2 shows a schematic configuration of an in-vehicle network system as an example of a data processing system according to the invention. In FIG. 2, five electronic control units (hereinafter also abbreviated as ECUs) 101 to 105 coupled to a CAN bus (CANBUS) 100 as an example of a network bus are illustrated, and the ECUs 101 to 105 each include a microcomputer MCU and other devices IC. The ECU 101 is an ECU for body operating switches, the ECU 102 is an ECU for an electric-powered retractable seat, the ECU 103 is an ECU for a sunroof, the ECU 104 is an ECU for a memory mirror, and the ECU 105 is an ECU for a console system such as a speedometer. A sunroof switch, a memory mirror switch, and an electric-powered retractable seat switch are illustrated as operating switches.

The ECUs 101 to 105 exchange information with one another in units of frames of a specified format. The format of a frame has an SOF (Start Of Frame) as a start, a frame ID as a frame identifier (ID), a control data field indicating a data length etc., a data field in which CAN data as a message is arranged, a CRC sequence field, an EOF (End Of Frame).

In a CAN communication method, basically a CAN node that manages data transmits a data frame, and a CAN node that requires the data receives the data. Alternatively, a CAN node that requires data transmits a remote frame, and a corresponding CAN node sends a data frame. An ECU that transmits a remote frame makes a request to a node identified by a frame ID for data corresponding to a data type. An ECU that transmits a data frame in response to the remote frame sends data having the frame ID attached thereto in response to the request. The ID of the data frame to be requested is set to the frame ID of the remote frame, and the frame ID of the request remote frame is attached to the frame ID of the data frame. Specifically, the frame ID of the data frame is used to identify data content and a transmission node.

<<Microcomputer Incorporated in ECU>>

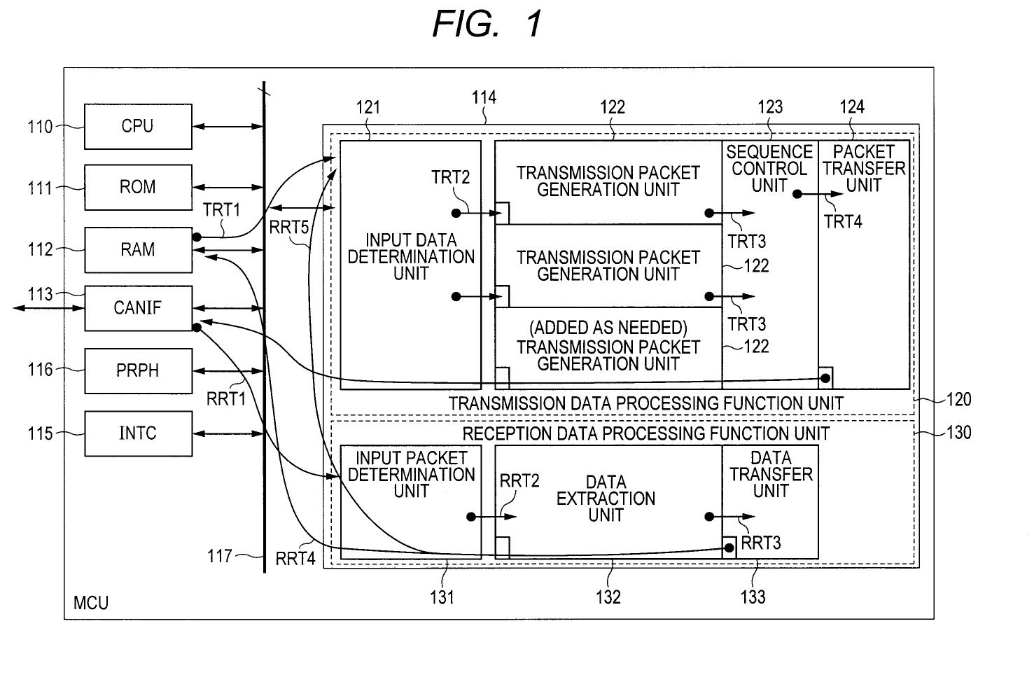

FIG. 1 illustrates the configuration of the microcomputer MCU incorporated in the ECU. Although not restricted, the microcomputer MCU is formed over a single semiconductor substrate made of, e.g., single-crystal silicon, using a known CMOS integrated circuit manufacturing technology. The microcomputer MCU includes a central processing unit (CPU) 110 for executing programs, ROM 111 for storing programs which the central processing unit 110 executes and control data, a RAM 112 which is used as a work area of the CPU 110, a CAN interface circuit (CANIF) 113, a function reconfiguration module 114, an interrupt controller (INTC) 115 for performing control to receive interrupt requests from inside and outside the microcomputer MCU and provide interrupt signals to the CPU 110, and other peripheral circuitry (PRPH) 116. These circuit modules input and output necessary data, addresses, and other information via an internal bus 117.

The CAN interface circuit 113 is an example of an external interface circuit, and is coupled to the CAN bus 100. The CAN interface circuit 113 controls physical coupling with the CAN bus 100 to input and output the data frame and the remote frame.

<<Transmission Data Processing Function and Reception Data Processing Function set in Function Reconfiguration Module>>

The function reconfiguration module 114 is a variable logic function module in which logic functions according to written function definition data are set. The ROM 111 stores the function definition data as part of control data. The CPU 110 writes the function definition data stored in the ROM 111 to the function reconfiguration module 114 to set a transmission data processing function and a reception data processing function of a frame which the CAN interface circuit 113 transmits and receives, and uses the set transmission data processing function and reception data processing function. The transmission data processing function and the reception data processing function are implemented by the function reconfiguration module 114 instead of adopting software processing by the CPU 110 or processing by dedicated hardware. On the other hand, software processing by the CPU 110 or processing by dedicated hardware is adopted for generation of transmission data supplied to the transmission data processing function and data processing after processing by the reception data processing function.

The function reconfiguration module 114 in which the transmission data processing function and the reception data processing function have been set have a transmission data processing function unit 120 and a reception data processing function unit 130.

The transmission data processing function unit 120 includes an input data determination unit 121 for determining the data ID of transmission data sequentially generated through data processing by the CPU 110 and supplied via the RAM 112, a plurality of transmission packet generation units 122 each for receiving transmission data corresponding to the data ID determination result by the input data determination unit 121 and configuring a packet to be transmitted, a sequence control unit 123 for controlling the transmission sequence of the packet generated by each transmission packet generation unit 122 and outputting the packet, and a packet transfer unit 124 for providing the packet outputted from the sequence control unit 123 to the CAN interface circuit 113.

A data processing flow by the transmission data processing function unit 120 will be described. When a predetermined event such as an external interrupt request or an internal interrupt request occurs, the interrupt controller 115 provides the trigger of the received interrupt request to the CPU 110 and asserts an interrupt signal to the CPU 110. In response to the interrupt request, the CPU 110 starts data processing, generates transmission data and a data ID, and supplies the generated transmission data and data ID to the function reconfiguration module 114 via the RAM 112. That is, data to be transmitted is inputted to the transmission data processing function unit 120 via the RAM 112 by the CPU 110 (TRT1). The inputted transmission data and data ID is determined by the input data determination unit 121, and the transmission data and the data ID are transferred to a transmission packet generation unit 122 corresponding to the determined data ID (TRT2). The transmission packet generation unit 122 to which the transmission data and the data ID have been transferred generates a packet in accordance with a predetermined packet format conforming to CAN frame specifications, and sends the generated packet to the sequence control unit 123 (TRT3). The sequence control unit 123 performs transmission priority control of packets inputted from the plurality of transmission packet generation units 122, and supplies a high-transmission-priority packet to the packet transfer unit 124 (TRT4). The packet transfer unit 124 supplies the packet to the CAN interface circuit 113 that is ready for transmission (TRT5). The CAN interface circuit 113 outputs the received packet as a remote frame or a data frame to the CAN bus 100.

The reception data processing function unit 130 includes an input packet determination unit 131 for determining the packet ID of a reception packet supplied from the CAN interface circuit 113, a data extraction unit 132 for extracting necessary reception data based on the configuration of a packet corresponding to the packet ID determination result by the input packet determination unit 131, adding a corresponding data ID to the reception data, and storing them, and a data transfer unit 133 for supplying the reception data and the data ID stored in the data extraction unit 132 to a transfer destination unit in accordance with the state of the transfer destination unit.

In the reception data processing function unit 130, upon receiving a data frame or a remote frame from the CAN bus 100, the CAN interface circuit 113 supplies the packet (frame itself or substantial data excluding codes such as SOF and EOF) to the input packet determination unit 131 in accordance with a request from the input packet determination unit 131 (RRT1). The input packet determination unit 131 passes the packet to the data extraction unit 132 after determining that the subsequent stage is ready for reception (RRT2). The data extraction unit 132 determines a packet ID held by the passed packet, extracts necessary reception data, adds a data ID to the reception data, and supplies the reception data and the data ID to the data transfer unit 133 (RRT3). Based on the data ID, the data transfer unit 133 transfers the reception data and the data ID to the RAM 112 via the CPU 110 (RRT4), or transfers the reception data and the data ID to the transmission data processing function unit 120 for transmission processing if a gateway function is set to the data ID (RRT5).

<<Outline of Hardware Configuration of Function Reconfiguration Module>>

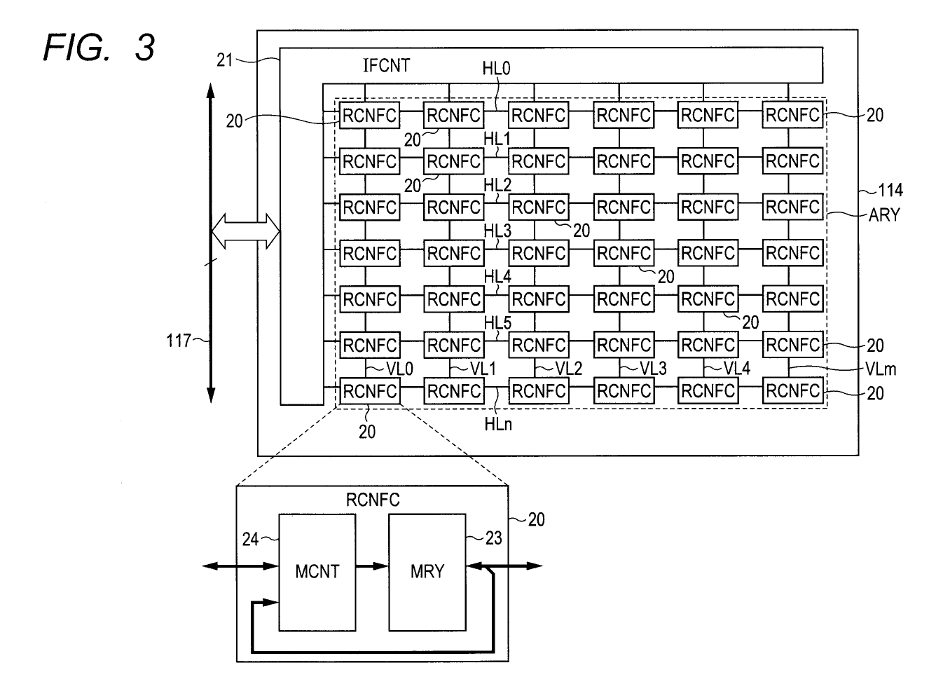

FIG. 3 shows an example of the function reconfiguration module 114. The function reconfiguration module 114 has a function reconfiguration array CARY in which a plurality of function reconfiguration cells (RCNFC) 20 each having a memory circuit (MRY) 23 and a control circuit (MCNT) 24 are arranged in chains through lines HL0 to HLn and VL0 to VLm and an interface control circuit (IFCNT) 21 for controlling a function reconfiguration cell 20 in response to an access request from the internal bus 117. The function reconfiguration cell 20 performs a logic operation by repeating an operation in which the control circuit 24 receives a signal read from the memory circuit 23 or a signal supplied from the internal bus 117, accesses the memory circuit 23 in accordance thereto, and determines the next access address to the memory circuit 23 based on the thereby obtained signal. The memory circuit 23 stores function definition data for defining the logic operation and data to be operated in the logic operation. That is, predetermined function definition data as logic function setting information is stored in the memory circuit 23 of the function reconfiguration module 114 via the internal bus 117 by the CPU 110 or the like, thereby variably setting logic functions. In this example, the transmission data processing function unit 120 and the reception data processing function unit 130 are set. For the set logic functions, the CPU 110 or the CAN interface circuit 113 accesses a predetermined address via the internal bus 117, thereby performing transmission data processing and reception data processing in the function reconfiguration module 114.

With the above configuration of the function reconfiguration module 114, the function reconfiguration cell 20 can autonomously control the reading of the memory circuit 23, so that the memory circuit 23 for implementing variable logic functions can be treated as a circuit equivalent to a logic circuit. Accordingly, it is possible to provide flexibility to feasible logical configuration and size. Further, it becomes possible to implement variable logic functions that can support a large logical size in a small chip occupation area. Furthermore, in comparison with a program processing apparatus which fetches and executes sequential instructions, feedback processing in which each function reconfiguration cell 20 determines the next operation based on data read from the memory circuit 23 is repeated, which can contribute to the speed enhancement of the logic operation.

A further specific example which can be adopted as the hardware configuration of the function reconfiguration module will be supplementarily described at the end.

<<Transmission Data Processing Function Unit>>

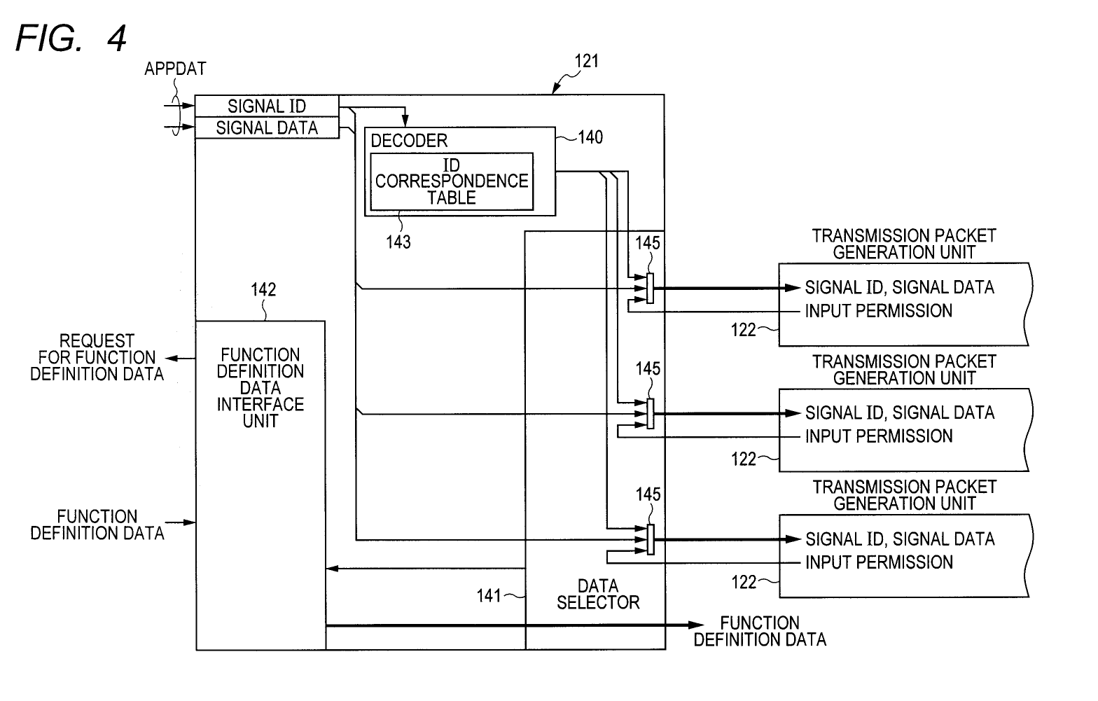

The transmission data processing function unit 120 will be detailed. FIG. 4 illustrates the details of the input data determination unit 121. The input data determination unit 121 receives the data ID (also referred to as a signal ID) and transmission data (also referred to as signal data) as application generation data APPDAT generated by executing an application program by the CPU 110. The input data determination unit 121 has a decoder 140 for decoding the signal ID, a data selector 141 for outputting the signal data and the signal ID to a transmission packet generation unit corresponding to the signal ID based on a decoding result by the decoder 140, and a function definition data interface unit 142.

A dedicated register address or memory address is mapped to the function definition data interface unit 142, and the CPU 110 or the like writes function definition data to the address, thereby making it possible to perform initial function setting of the transmission data processing function unit 120. Although the details will be described later, the function definition data interface unit 142 provides notice to the CPU 110, thereby making it possible to set a logic function needed later.

The decoder 140 has an ID correspondence table 143 indicating the correspondence between the signal ID and the packet ID, and determines a packet ID corresponding to an inputted signal ID. If there is no packet ID corresponding to the signal ID, the decoder 140 causes the function definition data interface unit 142 to output a function definition data request signal to cause the CPU 110 to reset the ID correspondence table 143. In this embodiment, the packet ID configures a frame ID transmitted to a CAN network, and is also referred to as a CAN ID for convenience sake.

The selector 141 has select gates 145 one-to-one corresponding to the transmission packet generation units 122. A select gate 145 gets input permission for the signal data etc. from the corresponding transmission packet generation unit 122, and sends the signal ID and the signal data to the subsequent transmission packet generation unit 122 on condition that the selection signal of the packet generation unit assigned for generation of the packet of the packet ID corresponding to the signal ID is enabled by the decoder 140. The input permission for the signal data is regarded as a signal representing a packet generation state of the corresponding transmission packet generation unit 122, and the input permission state is a state of being ready for generation of a new packet.

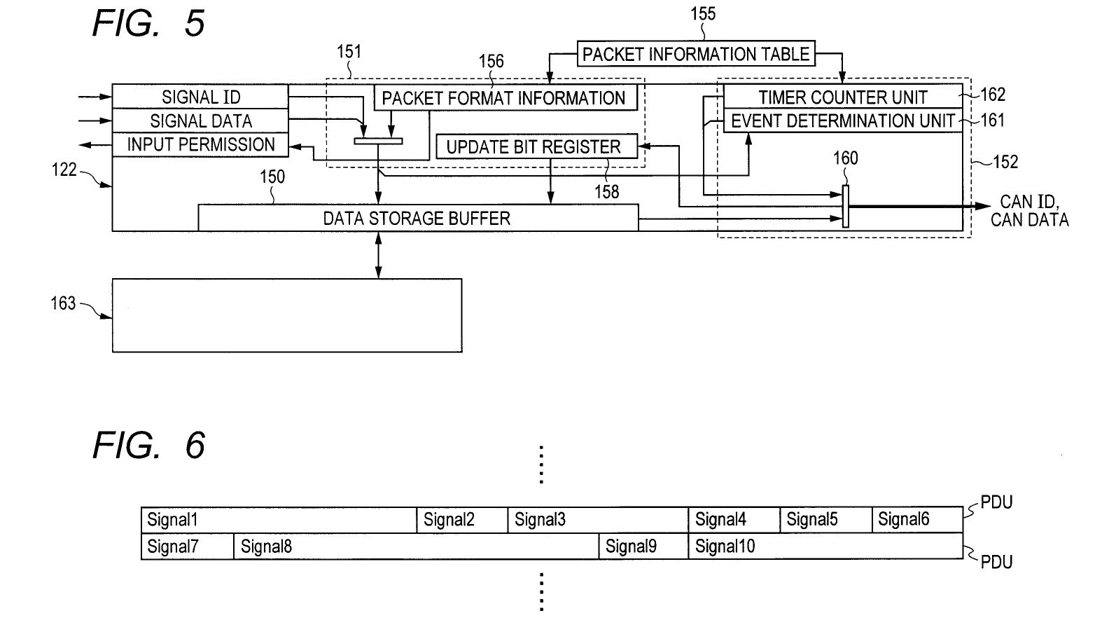

FIG. 5 illustrates the details of the transmission packet generation unit 122. The transmission packet generation unit 122 has a data storage buffer 150 as a data buffer memory, a pack unit 151 for storing the signal data supplied from the input data determination unit 121 in the data storage buffer 150 in accordance with a predetermined packet format to generate a packet, and a packet selector 152 for sending the packet stored in the data storage buffer 150 to the sequence control unit 123 at the time of occurrence of a predetermined event.

The pack unit 151 has a select gate 157 for controlling the storage location of the signal data into the data storage buffer 150 in accordance with packet format information 156 read from a packet information table 155 and an update bit register 158 indicative of the location of the signal data updated in the packet format. In packet transmission, the value of the update bit register 158 is internally transferred to the data storage buffer 150 and contained in the packet.

The packet selector 152 has an output gate 160 for sending out the packet from the data storage buffer 150, an event determination unit 161, and a timer counter unit 162. The event determination unit 161 compares data supplied from outside the function reconfiguration module with corresponding data already stored in the data storage buffer memory 150, and outputs an event signal for instructing the output gate 160 to output the packet if a predetermined condition holds. For example, in the case where data used in the previous transmission is stored in the data storage buffer memory 150, if data supplied thereafter from outside to update data stored in the data storage buffer memory 150 has a predetermined condition for the corresponding data stored in the data storage buffer memory 150, the event determination unit 161 outputs the event signal. In accordance with time-out or count-up according to the set condition, the timer counter unit 162 generates an event signal for instructing the output gate 160 to output the packet. When the output gate 160 outputs the packet to the subsequent stage, the update bit register 158 is reset.

The packet outputted from the output gate 160 contains at least a CAN ID and CAN data, and corresponds to a CAN frame transmitted to the CAN network in the end, though not restricted. The CAN data contains the signal data, though not restricted. The packet generated by the transmission packet generation unit 122 represents a PDU which is a data unit used in each hierarchy of hierarchical software defined in the standard for in-vehicle software such as AUTOSAR (Automotive Open System Architecture). As illustrated in FIG. 6, the packet shown as the PDU (Protocol Data Unit) is a set of data units called “Signal”. Although not shown, the PDU also has information indicating which “Signal” the PDU has. Although not restricted, “Signal” corresponds to the signal data, and information indicating which corresponds to which “Signal” corresponds to the signal ID.

Reference numeral 163 denotes a save unit for packet data. When hardware resources assigned for the function setting of a transmission packet generation unit 122 are switched to the function setting of another transmission packet generation unit 122, if there is a packet in process, the data of the packet is backed up to the save unit 163. When function setting is made again on the transmission packet generation unit 122 for the packet, the data of the packet is restored from the save unit 163 to the data storage buffer 150.

Although not restricted, the ROM 111 retains the packet information table 155, and as needed, the packet format information 156 which is part thereof is written to the transmission packet generation unit 122 and used.

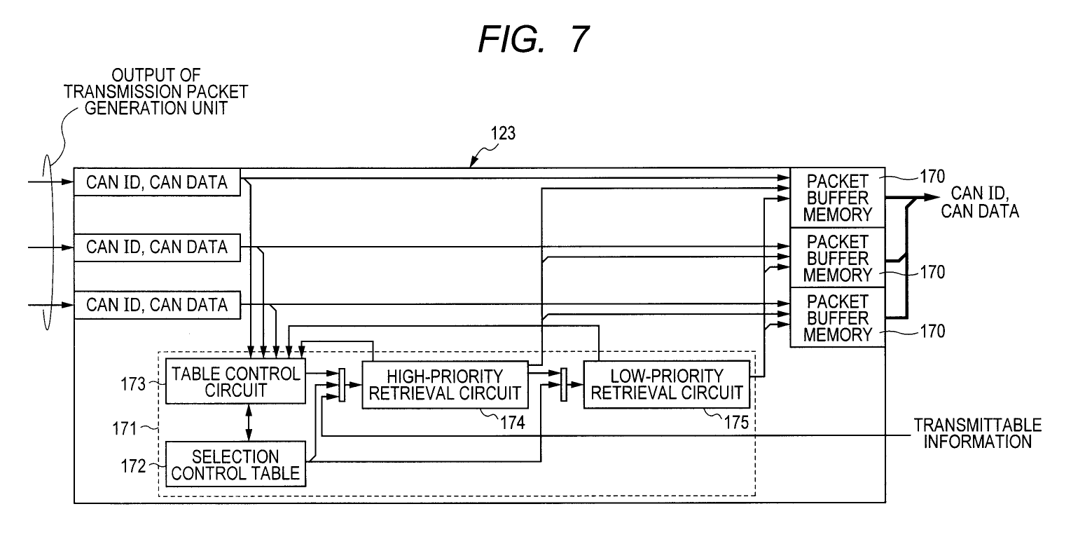

FIG. 7 illustrates the details of the sequence control unit. The sequence control unit 123 has packet buffer memories 170 for storing packets supplied from the transmission packet generation units 122 in association with the respective transmission packet generation units 122 and a priority control selector 171 for selecting packets in the packet buffer memories 170 in accordance with priority orders determined based on the priorities of the packets stored in the packet buffer memories 170 and the earliness of packet storage into the packet buffer memories 170.

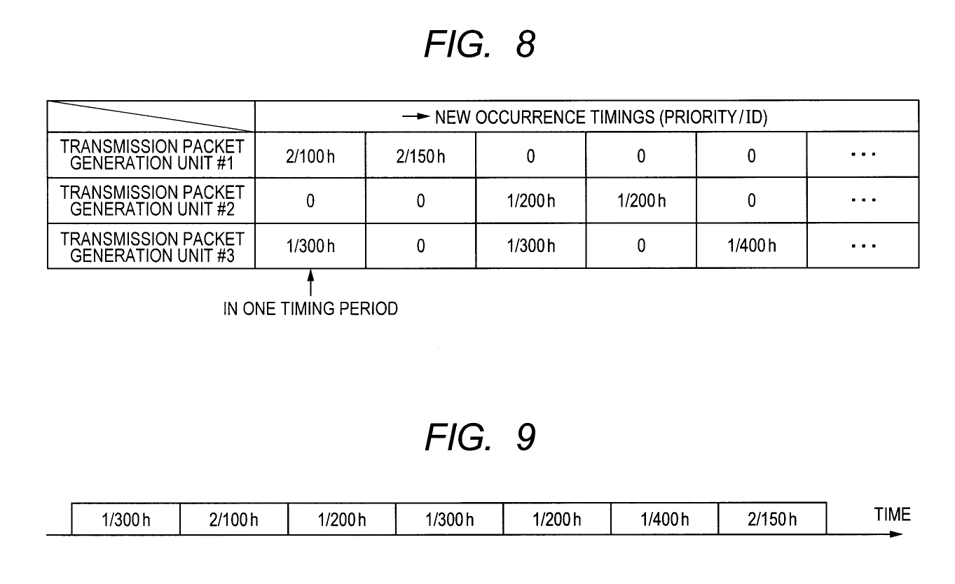

The priority control selector 171 stores, in a wraparound manner, table data for pairing the priority and CAN ID of the packet for each number of the transmission packet generation units 122 sequentially for each timing of packet supply from the transmission packet generation units 122, thereby to configure a selection control table 172. If priority=L and CAN ID=N, the table data is represented as (L/N). As illustrated in FIG. 8, the selection control table 172 stores the table data of the priorities and CAN IDs of packets for each timing of packet supply in association with the numbers of the transmission packet generation units 122 in which functions have been set. At the head of the table, there are stored table data (2/100h) for a transmission packet generation unit #1, table data 0 for a transmission packet generation unit #2, and table data (1/300h) for a transmission packet generation unit #3. At the next timing, there are stored table data (2/150h) for the transmission packet generation unit #1 and table data 0 for the transmission packet generation units #2 and #3. Table data 0 signifies no packet supply. The mapping addresses of the table data in the selection control table 172 are correlated with the location addresses of the packets in the packet buffer memories 170.

The selection control table 172 is updated by a table control circuit 173. A high-priority retrieval circuit 174 and a low-priority retrieval circuit 175 refer to the selection control table 172 to retrieve table data according to predetermined search logic. Based on the mapping addresses of the table data thereby obtained, the high-priority retrieval circuit 174 and the low-priority retrieval circuit 175 calculate the addresses of the packet buffer memories 170 to select packets, thereby reading the packets from the packet buffer memories 170.

Although not restricted, in retrieval determination by the high-priority retrieval circuit 174 and the low-priority retrieval circuit 175, high priority is assigned to “occurrence timing of packet supply”, followed by “priority level” and “ascending order of CAN IDs”. The high-priority retrieval circuit 174 retrieves the earliest, higher-priority, and smaller-CAN-ID table data from the selection control table 172, and the low-priority retrieval circuit 175 retrieves the earliest, lower-priority, and smaller-CAN-ID table data from the selection control table 172. FIG. 9 illustrates the selection sequence of table data retrieved using the selection control table 172 illustrated in FIG. 8.

The packets corresponding to the table data retrieved by the high-priority retrieval circuit 174 and the low-priority retrieval circuit 175 and read from the packet buffer memories 170 are deleted from the packet buffer memories 170. Further, the mapping addresses of the table data retrieved by the high-priority retrieval circuit 174 and the low-priority retrieval circuit 175 are transferred to the table control circuit 173, and after all the significant table data at the same occurrence timing is referred to, the table data at the same timing is deleted.

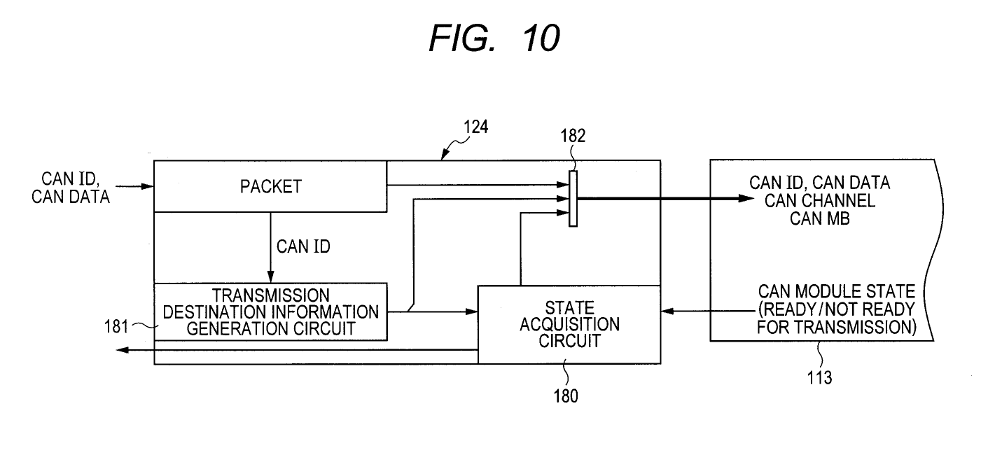

FIG. 10 illustrates the details of the packet transfer unit 124. The packet transfer unit 124 has a state acquisition circuit 180 for determining whether or not the CAN interface circuit 113 is ready for transmission, a transmission destination information generation circuit 181 for acquiring a CAN channel and a CAN message box (CAN MB) for transmitting the packet based on the CAN ID of the packet outputted from the sequence control unit 123, and a transfer gate 182 for providing the generated transmission destination information and the input packet to the CAN interface circuit 113 that is ready for transmission. The CAN channel is the number of a CANIF module coupled to the CAN bus 100, and the CAN message box is an internal RAM for storing CAN packets.

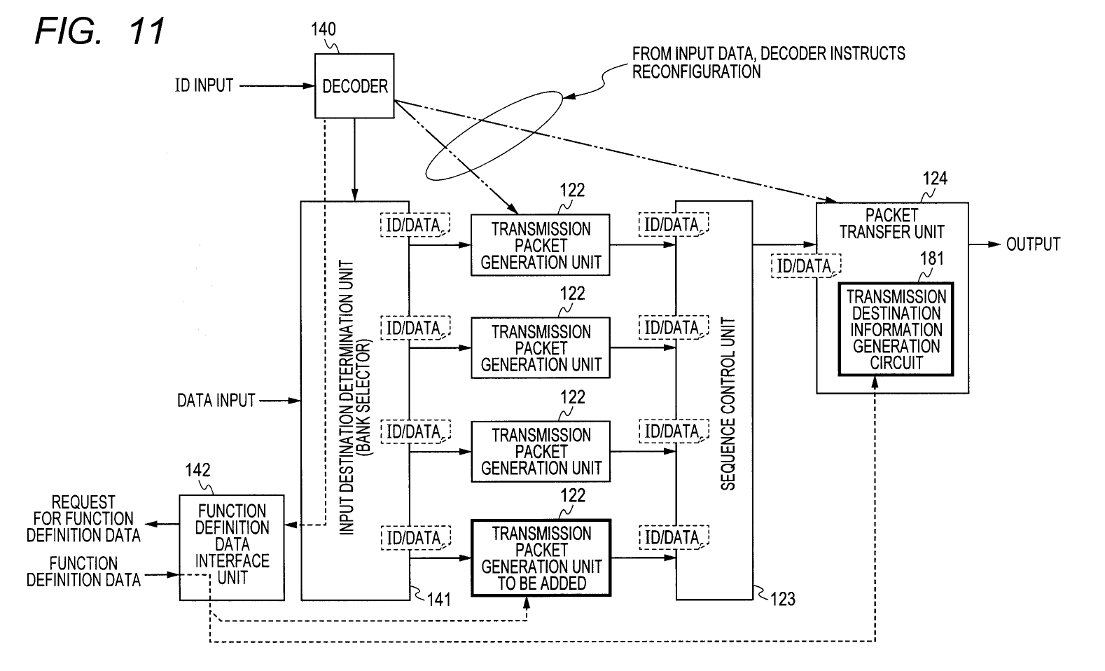

FIG. 11 shows the case of dynamically adding or switching the transmission data processing function set in the function reconfiguration module 114.

If there is no transmission packet generation unit corresponding to a determination result by the decoder 140 of the input data determination unit 121, the function reconfiguration module 114 makes a request to the CPU 110 via the function definition data interface unit 142 for the function setting of a necessary transmission packet generation unit 122, and resumes processing of the transmission data after the function is set. Further, when the function reconfiguration module 114 makes the request for the function setting of the necessary transmission packet generation unit 122, the function reconfiguration module 114 also makes a request to set, in the packet transfer unit 124, a transfer function for a packet generated by the transmission packet generation unit 122 set by the request. That is, the packet transfer function for which the setting request is made is the information generation function of the transmission destination information generation circuit 181 in FIG. 10.

<<Reception Data Processing Function Unit>>

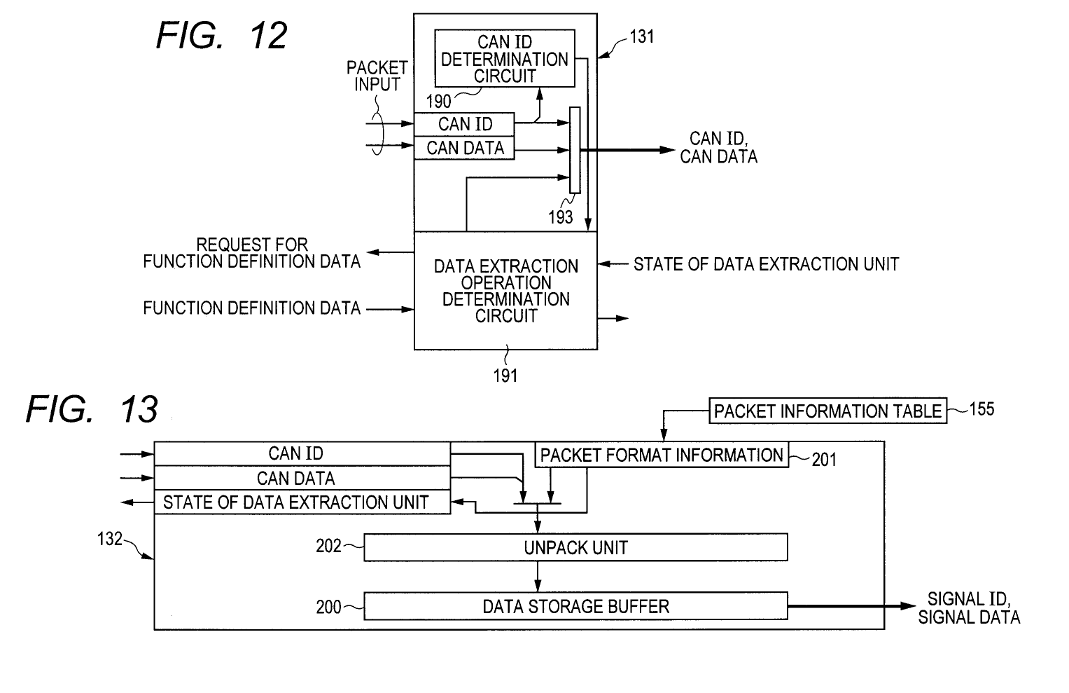

The reception data processing function unit 130 will be detailed. FIG. 12 illustrates the details of the input packet determination unit 131. The input packet determination unit 131 has a circuit 190 for determining a CAN ID and a circuit 191 for determining a data extraction operation by the data extraction unit 132. If the data extraction unit 132 has a data extraction function corresponding to the determined packet ID and can perform a data extraction operation for a new packet, the input packet determination unit 131 supplies the packet containing the CAN ID and CAN data to the data extraction unit 132 via a transfer gate 193.

FIG. 13 illustrates the details of the data extraction unit 132. The data extraction unit 132 has a data storage buffer 200 as a data buffer memory and an unpack unit 202 for separating reception data from the packet based on packet format information (information indicative of the configuration of the packet) 201 corresponding to the CAN ID determination result by the CAN ID determination circuit 190, adding a corresponding data ID to the separated reception data, and storing them in the data storage buffer 200.

Although not restricted, the packet format information 201 is read from the packet information table 155 retained by the ROM 111. If the data extraction unit 132 does not retain the packet format information 201 corresponding to the determination result by the CAN ID determination circuit 190, the data extraction unit 132 requests the CPU 110 via the data extraction operation determination circuit 191 to set necessary packet format information to the data extraction unit 132.

The reception data and the data ID stored in the data storage buffer 200 are supplied as signal data and a signal ID to the data transfer unit 133.

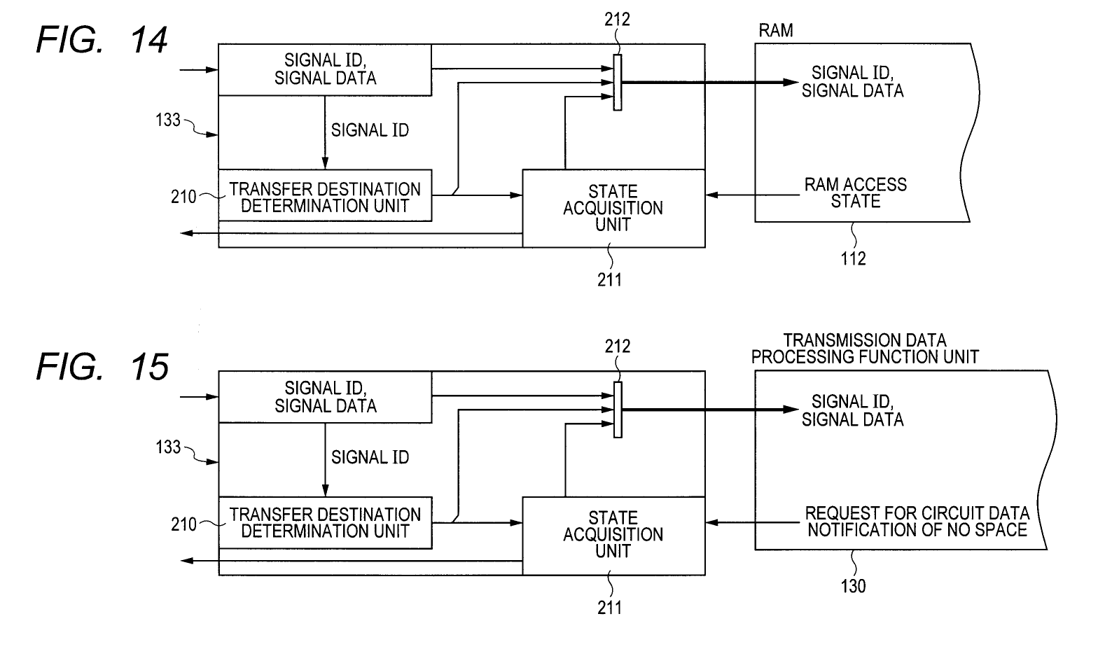

FIGS. 14 and 15 illustrate the details of the data transfer unit 133. The data transfer unit 133 has a transfer destination determination unit 210 for storing data transfer destination information corresponding to the signal ID and a state acquisition unit 211 for acquiring the state of a transfer destination unit. A transfer gate 212 acquires transfer destination information corresponding to the signal ID received from the data extraction unit 132 from the transfer destination determination unit 210, and outputs the signal data and the signal ID as well as the transfer destination information such as a transfer destination address when the state of the transfer destination unit indicates transfer permission. In FIG. 14, the transfer destination unit is the RAM 112, and the received data is stored in the RAM 112. In FIG. 15, the transfer destination unit is the transmission data processing function unit 120. In this case, the microcomputer MCU functions as a gateway, and the reception data is transferred to another ECU.

If the transfer destination determination unit 210 does not retain the transfer destination information corresponding to the signal ID, the state acquisition unit 211 requests the CPU 110 via the data extraction operation determination circuit 191 to set necessary transfer destination information to the data transfer unit 133.

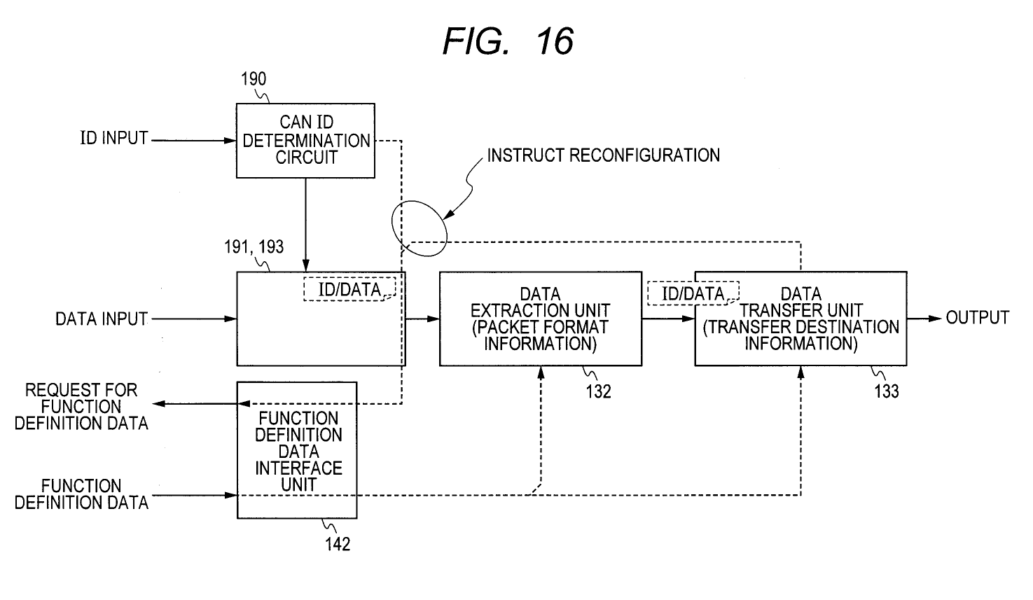

FIG. 16 shows the case of dynamically adding or switching the reception data processing function set in the function reconfiguration module 114.

If a function of the data extraction unit 132 corresponding to the inputted CAN ID determined by the CAN ID determination circuit 190 is not set, the function reconfiguration module 114 requests the central processing unit 110 to set packet format information for necessary data extraction, and resumes processing of the packet after the function is set. Further, if a function of the data transfer unit 133 to the transfer destination unit corresponding to the reception data and the data ID is not set, the function reconfiguration module 114 requests the central processing unit 110 to set necessary transfer destination information to the data transfer unit 133, and outputs the reception data and the data ID to the transfer destination unit after the function is set.

While, in FIG. 1, the function reconfiguration module 114 includes e.g. three transmission data processing function units and one reception data processing function unit, the function reconfiguration module 114 can have logical size for configuring a transmission packet generation unit and a data extraction unit for relatively frequently processing packets transmitted and received at regular time intervals and one or two transmission packet generation units 122 or a data extraction unit 132. Processing for frequently-processed packets is almost constantly configured in the function reconfiguration module 114, whereas processing for infrequently-processed packets is configured as needed in the function reconfiguration module 114, dynamic coupling configuration is set up so as to receive data from either the input data determination unit 121 or the input packet determination unit 131, and dynamic reconfiguration is set up so as to send a processing result to either the sequence control unit 123 or the data transfer unit 133. The constantly configured transmission packet generation unit 122 and data extraction unit 132 may differ among the ECUs.

<<Supplement of Hardware Configuration of Function Reconfiguration Module>>

Lastly, a specific example of the hardware configuration of the function reconfiguration module 114 will be supplemented. The description made below conforms to the description in WO2008/143285.

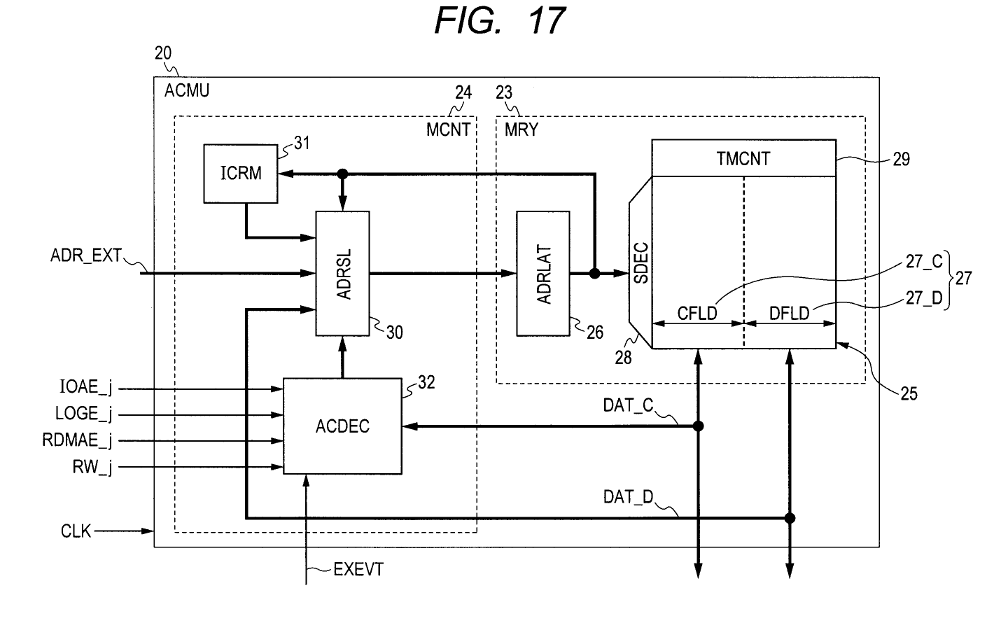

FIG. 17 shows an example of a function reconfiguration cell 20. The function reconfiguration cell 20 has a memory circuit (MRY) 23 and a control circuit (MCONT) 24. The memory circuit (MRY) 23 is configured with, for example, a single-port static random access memory (SRAM) 25 and an address latch circuit (ADRLAT) 26. The SRAM 25 includes a memory array 27, an address decoder (SDEC) 28, and a timing controller (TMCNT) 29. The memory array 27 has a data field (DFLD) 27_D and a control field (CFLD) 27_C which are accessed with an address signal supplied from the address latch circuit 26. The address decoder (SDEC) 28 decodes the address signal outputted from the address latch circuit (ADRLAT) 26 and selects accessible-unit memory cells from the data field (DFLD) 27_D and the control field (CFLD) 27_C. The timing controller (TMCNT) 29 controls a read operation or a write operation specified by a read/write signal RW_j (j=0 to m) for the selected accessible-unit memory cells.

The control circuit 24 has a selector (ADRSL) 30 for supplying the address signal to the address latch circuit 26, an address incrementer (ICRM) 31 for incrementing the address signal latched by the address latch circuit 26 by +1, and an access control decoder (ACDEC) 32. Information DAT_D read from the data field 27_D, the output of the address incrementer 31, and address information ADR_EXT which is part of access address information supplied from a bus SBUS or PBUS are inputted to the selector 30. Control information DAT_C read from the control field 27_C, an external event signal EXEVT, a random access selection signal RDMAE_j for the function reconfiguration cell 20, a logic enable signal LOGE_j, and an IO access selection signal IOAE_j are supplied to the access control decoder 32, which controls the output operation of the selector 30 based thereon. The memory array 27 further has an address field (AFLD) (not shown) and a path (DAT_A) for inputting the output of the address field to the selector 30, which makes it possible to access the memory array 27 and use output from the address field as the next access address for the memory array 27 by the access control decoder.

When the random access selection signal RDMAE_j is active, the access control decoder 32 causes the selector 30 to select the address information ADR_EXT and instructs the timing controller 29 to perform an access operation according to a read/write signal RW_j in accordance with the address information ADR_EXT. Thereby, in the SRAM 25, it becomes possible to randomly access the address specified by the address information ADR_EXT.

When the IO access selection signal IOAE_j is active and a read operation is specified by the read/write signal RW_j, the access control decoder 32 instructs the timing controller 29 to perform a read access operation in accordance with the latched address information while maintaining the address latch state of the address latch circuit 26 at that moment. Thereby, when the IO access selection signal IOAE_j of the function reconfiguration cell 20 is active, it becomes possible to access a memory area selected at that moment in the SRAM 25, which enables access equivalent to reading from one memory-mapped IO data register, to the SRAM 25. When the IO access selection signal IOAE_j is active and a write operation is specified by the read/write signal RW_j, the access control decoder 32 causes the selector 30 to select the address information ADR_EXT which is set in the address latch 26, so that a read address in the SRAM 25 can be initialized. Thus, the address latch circuit 26 subjected to writing when the IO access selection signal IOAE_j is enabled can be regarded as a register equivalent to a memory-mapped IO register subjected to writing. This equivalent register is referred to as an equivalent IO register for start address setting. Further, the memory area in the SRAM 25 subjected to reading when the IO access selection signal IOAE_j is enabled can be regarded as a register equivalent to a memory-mapped IO register subjected to reading. This equivalent register is referred to as an equivalent IO register for data reading.

When the logic enable signal LOGE_j is active, the access control decoder 32 repeatedly activates the memory read cycle of the SRAM 25 during the active period with the address held by the address latch 26 at that moment as a start address, and controls the selection operation of the selector 30 in accordance with the control information DAT_C read from the control field 27_C in each cycle. When the external event signal EXEVT is enabled, the access control decoder 32 causes the address selector 30 to output a specific address (e.g., the start address of the SRAM 25) in the memory read cycle. The address latch 26 which holds the start address when the logic enable signal LOGE_j is enabled can be regarded as a register equivalent to a memory-mapped IO register subjected to writing of an enable bit for instructing the start of a logic operation. This equivalent register is referred to as an equivalent IO register for enabling logic.

According to this function reconfiguration cell 20, the function reconfiguration cell 20 can autonomously control the reading of the memory circuit 23. For example, the control circuit 24 can autonomously control the next read address of the SRAM 25, based on the information DAT_C of the control field CFLD previously read from the SRAM 25 or the external event signal EXEVT inputted to the access control decoder 32. Thereby, the memory circuit 23 for implementing variable logic functions can be treated as a circuit equivalent to a logic circuit. Accordingly, it is possible to provide flexibility to feasible logical configuration and size. Further, it becomes possible to implement variable logic functions that can support a large logical size in a small chip occupation area.

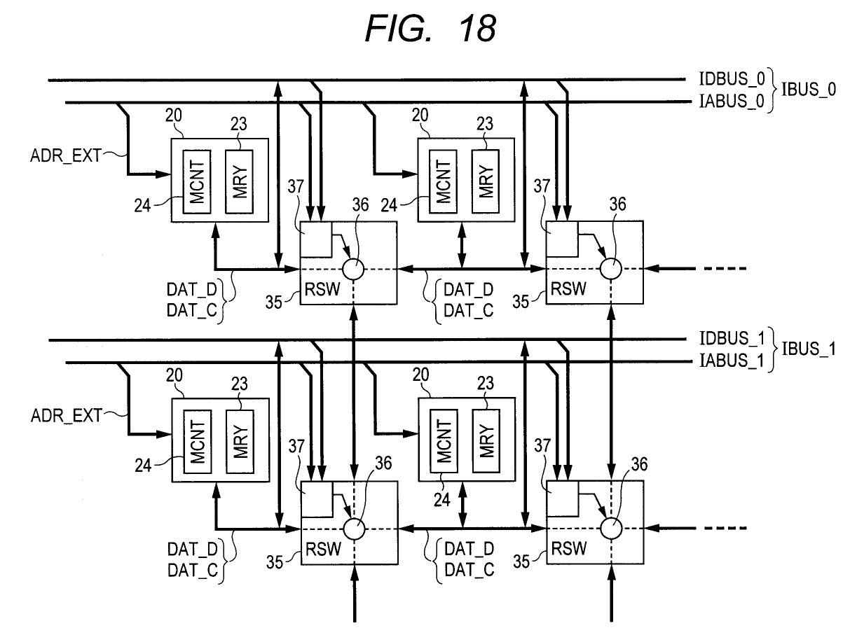

FIG. 18 illustrates the array configuration of a plurality of function reconfiguration cells 20. The function reconfiguration cells 20 are arranged in a matrix, and a coupling path selection circuit (RSW) 35 is disposed between laterally adjacent function reconfiguration cells 20. The function reconfiguration cells 20 and coupling path selection circuits 35 in each row are coupled to an internal bus IBUS_i (i=0, 1, . . . ). The internal bus IBUS_i is divided broadly into an address bus IABUS_i and a data bus IDBUS_i. The internal address bus IABUS_i supplies the above-mentioned address ADR_EXT to the control circuit 24. The internal data bus IDBUS_i transfers the information DAT_C and DAT_D between memory circuits 23. The coupling path selection circuit 35 has a switch circuit 36 for selectively coupling the transfer path of the data DAT_C and DAT_D of the function reconfiguration cell 20 between vertically or laterally adjacent function reconfiguration cells 20 and a coupling memory circuit 37 for storing switch control information of the switch circuit 36. The coupling memory circuit 37 is randomly accessed via the internal buses IABUS_i and IDBUS_i so that required switch control information is set therein.

Since the data DAT_C and DAT_D of one function reconfiguration cell 20 can be transferred to the data DAT_C and DAT_D of another function reconfiguration cell 20, the above-mentioned autonomous control can be effected over a plurality of function reconfiguration cells 20 in an interlinked manner. It becomes possible to implement one unit of logic function by operating the function reconfiguration cells 20 in series or in parallel.

By random access, configuration information as function definition data for defining a logic function is set in the memory circuit 23 of the function reconfiguration cell 20 and configuration information for defining a coupling path is set in the coupling memory circuit 37 of the coupling path selection circuit 35. When a function reconfiguration cell 20 in which a logic function has been set is instructed to start a logic operation, information obtained by the logic operation can be transferred to another function reconfiguration cell 20 located laterally or vertically adjacent to the cell via the coupling path selection circuit 35, and information obtained by the logic operation of the function reconfiguration cell 20 can also be read externally via the corresponding bus IBUS_i by an access operation equivalent to the reading of the memory-mapped IO register.

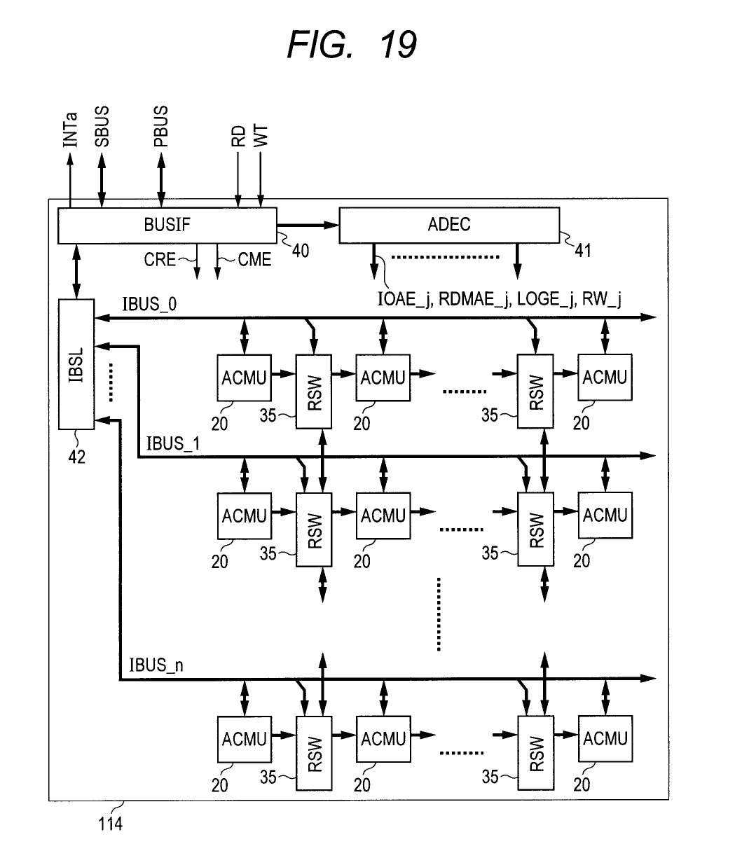

FIG. 19 illustrates the overall configuration of the function reconfiguration module 114. The module has a bus interface circuit (BUSIF) 40, an address decoder (ADEC) 41, and an internal bus selection circuit (IBSL) 42 which configure the interface control circuit for controlling the array of function reconfiguration cells 20 and coupling path selection circuits 35 illustrated in FIG. 18 in response to an access request from the bus SBUS or PBUS.

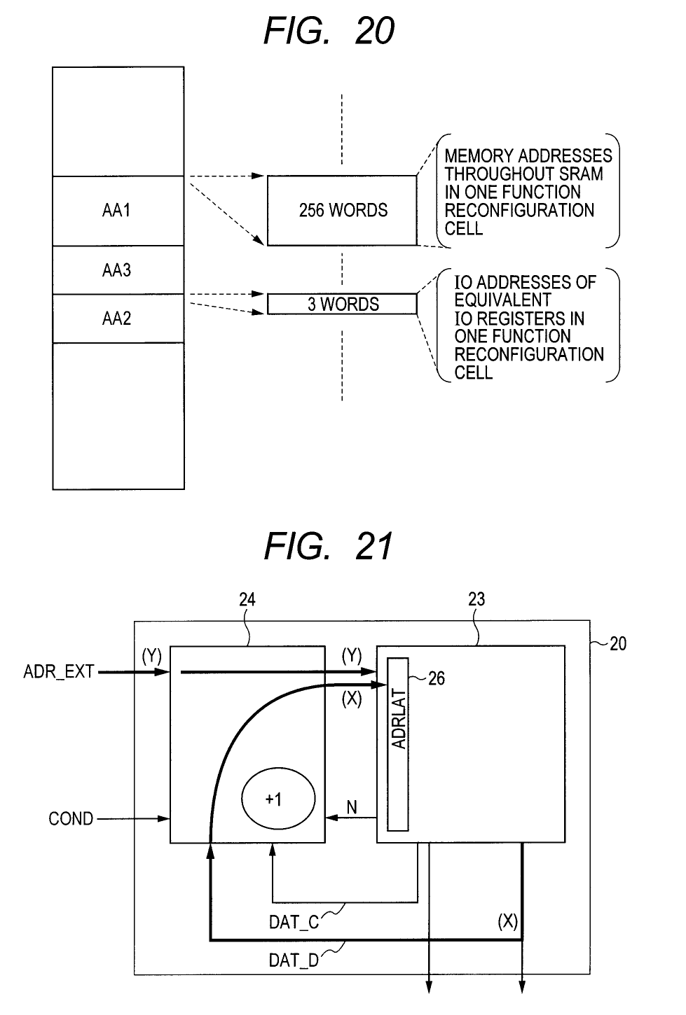

As illustrated in FIG. 20, addresses in a first address range AA1 are mapped onto the memory area (the storage area of the SRAM 25) of the memory circuit 23 of each function reconfiguration cell 20. The first address range AA1 corresponds to an address space that accounts for a part of the memory space coupled to the system bus SBUS. Addresses in a second address range AA2 are mapped onto the equivalent IO register for start address setting, the equivalent IO register for data reading, and the equivalent IO register for enabling logic which can be regarded as the equivalent memory-mapped IO registers for each function reconfiguration cell 20. In FIG. 20, 256 words are allocated for addresses in the SRAM in one function reconfiguration cell, and three words are allocated for addresses in the three equivalent memory-mapped IO registers in one function reconfiguration cell. The second address range AA2 corresponds to an address space that accounts for apart of the memory-mapped IO address space assigned to registers or the like in peripheral circuits coupled to the bus 117. Addresses in a third address range AA3 are mapped onto the memory area of the coupling memory circuit 37. The third address range AA3 corresponds to an address space that accounts for a part of the memory space coupled to the system bus SBUS or the bus 117.

In response to an access request from the CPU 110, a bus state controller (not shown) performs bus control of the bus 117. Upon a request for access to the first or third address range AA1 or AA3, the bus state controller performs access control as access to a memory address space in the address space of the CPU 110. Upon a request for access to the second address range AA2, the bus state controller performs access control as access to an IO address space in the address space of the CPU 110. The bus interface circuit 40 of the function reconfiguration module 114 bus interface circuit 40 receives any access to the first to third address ranges. Upon a request for access to the first or third address range AA1 or AA3, the bus interface circuit 40 activates a memory window enable signal CME. Upon a request for access to the second address range AA2, the bus interface circuit 40 activates a logic window enable signal CRE. Whether the access request is for input or output of data is determined by a read signal RD and a write signal WT issued from the access request source. The memory window enable signal CME and the logic window enable signal CRE are supplied to, e.g., the address decoder 41.

The address decoder 41 decodes upper bits of the address signal of an access request and determines which circuit of the function reconfiguration cells 20 and coupling path selection circuits 35 in the array arrangement is specified. When a coupling path selection circuit 35 is specified, the address decoder 41 enables the coupling memory circuit 37 in the circuit and causes the bus selection circuit 42 to select the corresponding internal bus IBUS_i to couple it to the system bus SBUS, thus making the coupling memory circuit 37 accessible randomly using lower address information of the address signal of the access request. Thereby, the CPU 110 or the like can arbitrarily define the coupling between function reconfiguration cells 20 by writing to the coupling memory circuit 37 by random access with a specified address in the third address range AA3.

When the address decoder 41 determines by address decoding that a function reconfiguration cell 20 is specified by an address in the address range AA1, the address decoder 41 activates RDMAE_j assigned to the function reconfiguration cell and causes the bus selection circuit 42 to select the corresponding internal bus IBUS_i to couple it to the system bus SBUS, thus making the coupling memory circuit 37 accessible randomly using lower address information of the address signal of the access request. Thereby, the CPU 110 or the like can arbitrarily define the logical configuration of the function reconfiguration cell 20 by writing to the SRAM 25 of the memory circuit 23 by random access with a specified address in the first address range AA1.

When the address decoder 41 determines by address decoding that an equivalent memory-mapped IO register in a function reconfiguration cell 20 is specified by an address in the address range AA2, the address decoder 41 activates IOAE_j or LOGE_j in accordance with the specified equivalent memory-mapped IO register and generates a read/write signal RW_j.

Specifically, at that moment, when a write operation is requested by a write signal WT specifying the equivalent IO register for start address setting via the bus 117, the address decoder 41 activates IOAE_j assigned to a function reconfiguration cell 20 specified by lower address information of the address signal of the access request, and specifies the write operation by the read/write signal RW_j. Thereby, write data is set in the ADRLAT 26 via the ADRSEL 30 in the function reconfiguration cell 20.

At that moment, when a read operation is requested by a read signal RD specifying the equivalent IO register for enabling logic via the bus 117, the address decoder 41 activates LOGE_j assigned to a function reconfiguration cell 20 specified by lower address information of the address signal of the access request, and specifies the read operation by the read/write signal RW_j. Thereby, the access control decoder 32 in the function reconfiguration cell 20 repeatedly activates the memory read cycle of the SRAM 25 during the active period with the address held by the address latch 26 at that moment as a start address. Data information DAT_D read from the data field 27_D in each cycle is fed back to the selector. The access control decoder 32 controls the selection operation of the selector 30 in accordance with the control information DAT_C read from the control field 27C in each cycle, thereby implementing a logic operation.

At that moment, when a read operation is requested by a read signal RD specifying the equivalent IO register for data reading via the bus 117, the address decoder 41 activates IOAE_j assigned to a function reconfiguration cell 20 specified by lower address information of the address signal of the access request, and specifies the read operation by the read/write signal RW_j. Further, the bus interface circuit 40 specifies the read operation by the read/write signal RW_j. Thereby, the bus interface circuit 40 receives information read from the memory area of the SRAM 25 selected by address information held by the ADRLAT 26 and outputs it as read data to the bus 117. Accordingly, the CPU 110 or the like can arbitrarily acquire the result of a logic operation performed by a function reconfiguration cell 20 in which a logic function has been set, by read access with a specified address in the second address range AA2. When the bus interface circuit 40 recognizes a request such as logic operation completion as one result of the logic operation, it can supply an interrupt signal to the interrupt controller 115. When the CPU 110 is thus given the interrupt signal, for example by specifying a read request to the equivalent IO register for data reading, the CPU 110 can move to an operation routine for acquiring the result of the logic operation from the function reconfiguration cell 20 that has finished the logic operation.

As described above, in addition to address mapping (first address range) for random access to the memory circuits, a particular address like a memory-mapped I/O address (an address in the second address range) assigned to the function reconfiguration cell is separately used for acquiring the result of a logic operation performed by the function reconfiguration cell in which a function has been set. This makes it easy to dynamically reconfigure the logic function for the function reconfiguration cell without changing the read address for acquiring the logic operation result produced by the dynamic reconfiguration.

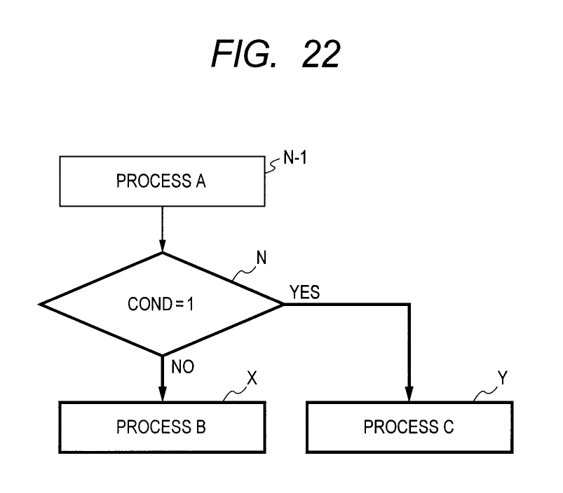

FIG. 21 shows the basic concept of a logic operation in the function reconfiguration cell 20. In condition COND=1, the control circuit 24 uses an address Y, which is the external address ADR_EXT, as an access address for the memory circuit 23. In condition COND=0, the control circuit 24 accesses the memory circuit 23 using an address specified by the data information DAT_D, following an internal sequence determined by the control information DAT_C. As is illustrated in FIG. 22, when a process A is executed following the internal sequence, it is possible to branch to a process B in accordance with an address specified by the data information DAT_D defined by the internal sequence in condition COND=0. It is also possible to branch to a process C specified by the external address ADR_EXT in condition COND=1. The above condition COND can be understood as a condition determined by an access mode for the function reconfiguration module 114 by the CPU 110 or the like and, moreover, as a condition determined by the control information DAT_C.

According to the microcomputer MCU described above, it is possible to manage the generation of the packet using the data ID for the transmission data generated by the central processing unit 110, perform transmission priority control of the generated packet, and perform transfer data control by providing the packet that has undergone the priority control to the external interface circuit. Since the transmission data processing function unit 120 set as the variable logic function is divided broadly into the input data determination unit 121, the transmission packet generation unit 122, the sequence control unit 123, and the packet transfer unit 124, no packet generation logic function corresponding to the data ID is coped with by exchanging logic functions, which facilitates effective utilization of limited hardware resources for function reconfiguration.

Further, it is possible to manage, using the data ID, the reception data corresponding to the packet ID of the received packet and control the transfer of the reception data in accordance with the state of the transfer destination unit corresponding to the data ID. Since the reception data processing function unit 130 set as the variable logic function is divided broadly into the input packet determination unit 131, the data extraction unit 132, and the data transfer unit 133, no definition information for data extraction corresponding to the packet ID can be coped with by addition or exchange and no transfer destination definition information corresponding to the data ID can be coped with by addition or exchange, which facilitates effective utilization of limited hardware resources for function reconfiguration.

Accordingly, it is possible to implement the communication control function by the microcomputer for the CAN network with the limited hardware resources of the electronic control unit without hampering the extensibility and degrading the processing performance. Further, it is possible to achieve both the extensibility and performance improvement of the communication control function in the CAN network system in which the plural electronic control units are coupled to the network bus.

While the invention made above by the present inventors has been described specifically based on the illustrated embodiments, the present invention is not limited thereto. It is needless to say that various changes and modifications can be made thereto without departing from the spirit and scope of the invention.

For example, the network system and the electronic control unit to which the invention is applied are not limited to the CAN network and the in-vehicle ECU, and can be applied to various network systems.

The semiconductor data processing device according to the invention is not limited to the single-chip microcomputer, and can also be implemented in the form of an SoC semiconductor integrated circuit, a multichip module, or the like.

The specific logical configurations of the transmission data processing function and the reception data processing function are not limited to the ones described above and can be changed as appropriate. Further, it is also possible to adopt a configuration for setting the transmission data processing function to the function reconfiguration module and causing CPU software processing to be burdened with the reception data processing function or a configuration for setting the reception data processing function to the function reconfiguration module and causing CPU software processing to be burdened with the transmission data processing function.

What is claimed is:

1. A semiconductor data processing device comprising:
an external interface circuit;
a function reconfiguration module in which a logic function according to written function definition data is set; and
a central processing unit which writes the function definition data to the function reconfiguration module to set, in the function reconfiguration module, a data processing function of data which the external interface circuit interfaces, and uses the set data processing function,
wherein the function reconfiguration module in which the data processing function has been set includes, as a transmission data processing function unit,
an input data determination unit for determining a data ID of transmission data sequentially generated and supplied through data processing by the central processing unit,
a plurality of transmission packet generation units each for receiving transmission data corresponding to a data ID determination result by the input data determination unit and configuring a packet to be transmitted,
a sequence control unit for controlling transmission sequence of the packet generated by each transmission packet generation unit and outputting the packet, and
a packet transfer unit for providing, to the external interface circuit, the packet outputted from the sequence control unit.

2. The semiconductor data processing device according to claim 1, wherein if there is no transmission packet generation unit corresponding to a determination result by the input data determination unit, the function reconfiguration module makes a request to the central processing unit for function setting of a necessary transmission packet generation unit, and resumes processing of the transmission data after the function is set.

3. The semiconductor data processing device according to claim 2, wherein when the function reconfiguration module makes the request for the function setting of the necessary transmission packet generation unit, the function reconfiguration module also makes a request to set, in the packet transfer unit, a transfer function for a packet generated by the transmission packet generation unit set by the request.

4. The semiconductor data processing device according to claim 1, wherein the input data determination unit includes a decoder for decoding the data ID and a data selector for outputting the transmission data and the data ID to a transmission packet generation unit corresponding to the data ID based on a decoding result by the decoder.

5. The semiconductor data processing device according to claim 4, wherein the transmission packet generation unit includes a data buffer memory, a pack unit for storing the transmission data supplied from the input data determination unit in the data buffer memory in accordance with a predetermined packet format to generate a packet, and a packet selector for sending the packet stored in the data buffer memory to the sequence control unit at the time of occurrence of a predetermined event.

6. The semiconductor data processing device according to claim 5, wherein the sequence control unit includes a packet buffer memory for storing the packet supplied from the transmission packet generation unit in association with the transmission packet generation unit and a priority control selector for selecting the packet in the packet buffer memory in accordance with a priority order determined based on a priority of the packet stored in the packet buffer memory and earliness of packet storage into the packet buffer memory.

7. The semiconductor data processing device according to claim 6, wherein the packet transfer unit includes a transfer gate for providing the packet selected by the priority control selector to the external interface circuit that is ready for transmission.

8. The semiconductor data processing device according to claim 1, wherein in response to an interrupt request according to a type of occurred event, the central processing unit starts data processing, generates transmission data and a data ID, and supplies the generated transmission data and data ID to the function reconfiguration module.

9. The semiconductor data processing device according to claim 8, wherein the transmission packet generation unit sends the generated packet to the sequence control unit at the time of occurrence of a predetermined event signal.

10. The semiconductor data processing device according to claim 9, wherein the transmission packet generation unit includes a timer counter unit for generating the predetermined event signal.

11. The semiconductor data processing device according to claim 9, wherein the transmission packet generation unit includes a data buffer memory for storing the transmission data supplied from the input data determination unit in accordance with a predetermined packet format and an event determination unit for comparing data supplied from outside the function reconfiguration module with corresponding data already stored in the data buffer memory and generating the predetermined event signal if a predetermined condition holds.

12. The semiconductor data processing device according to claim 1,
wherein the function reconfiguration module includes: a function reconfiguration array in which a plurality of function reconfiguration cells each having a memory circuit and a control circuit are arranged in chains through lines; and an interface control circuit for controlling a function reconfiguration cell in response to an access request from outside,
wherein the function reconfiguration cell performs a logic operation by repeating an operation in which the control circuit receives a signal read from the memory circuit or a signal supplied from outside, accesses the memory circuit in accordance thereto, and determines a next access address to the memory circuit based on a thereby obtained signal, and
wherein the memory circuit stores function definition data for defining the logic operation and data to be operated in the logic operation.

13. A semiconductor data processing device comprising:
an external interface circuit;
a function reconfiguration module in which a logic function according to written function definition data is set; and
a central processing unit which writes the function definition data to the function reconfiguration module to set, in the function reconfiguration module, a data processing function of data which the external interface circuit interfaces, and uses the set data processing function,
wherein the function reconfiguration module in which the data processing function has been set includes, as a reception data processing function unit:
an input packet determination unit for determining a packet ID of a reception packet supplied from the external interface circuit;
a data extraction unit for extracting necessary reception data based on a configuration of a packet corresponding to a packet ID determination result by the input packet determination unit, adding a corresponding data ID to the reception data, and storing them; and
a data transfer unit for supplying the reception data and the data ID stored in the data extraction unit to a transfer destination unit in accordance with a state of the transfer destination unit.

14. The semiconductor data processing device according to claim 13, wherein if a function of the data extraction unit corresponding to the packet ID determined by the input packet determination unit is not set, the function reconfiguration module makes a request to the central processing unit for necessary function setting of the data extraction unit, and resumes processing of the packet after the function is set.

15. The semiconductor data processing device according to claim 14, wherein if a function of the data transfer unit to the transfer destination unit corresponding to the reception data and the data ID is not set, the function reconfiguration module makes a request to the central processing unit for necessary function setting of the data transfer unit, and outputs the reception data and the data ID to the transfer destination unit after the function is set.

16. The semiconductor data processing device according to claim 15, wherein the data extraction unit includes a data buffer memory and an unpack unit for separating the reception data from the packet based on the configuration of the packet corresponding to the packet ID determination result by the input packet determination unit, adding the corresponding data ID to the separated reception data, and storing them in the data buffer memory.

17. The semiconductor data processing device according to claim 13,
wherein the function reconfiguration module includes: a function reconfiguration array in which a plurality of function reconfiguration cells each having a memory circuit and a control circuit are arranged in chains through lines; and an interface control circuit for controlling a function reconfiguration cell in response to an access request from outside,
wherein the function reconfiguration cell performs a logic operation by repeating an operation in which the control circuit receives a signal read from the memory circuit or a signal supplied from outside, accesses the memory circuit in accordance thereto, and determines a next access address to the memory circuit based on a thereby obtained signal, and
wherein the memory circuit stores function definition data for defining the logic operation and data to be operated in the logic operation.
